(19) United States
(12) Patent Application Publication
(10) Pub. No.: US 2007/0115761 A1
(43) Pub. Date: May 24, 2007

(54) DISPLAYING STORAGE INFORMATION ON PORTABLE STORAGE DEVICE

(75) Inventor: Chang Suk SONG, Seocheon-gun (KR)

Correspondence Address: FISH & RICHARDSON P.C., P.O. BOX 1022, MINNEAPOLIS, MN, 55440-1022, US

(73) Assignee: LG ELECTRONICS, INC., Youngdungpo-gu (KR)

(21) Appl. No.: 11/555,640

(22) Filed: Nov. 1, 2006

(30) Foreign Application Priority Data
Nov. 24, 2005 (KR) 2005-0112932

(51) Int. Cl. G11B 11/00

(52) U.S. Cl. 369/13.01

(57) ABSTRACT

A portable storage device includes a connector configured for operatively connecting to a host and a storage medium. The storage medium includes a data area for storing data, and an information area configured to store memory information relating to file resource allocation associated with file data stored within the data area. The portable storage device includes a control unit configured to store file data transmitted from the host into the data area, to store the memory information in the information area if the portable storage device is operatively connected to the host, and to read the memory information stored in the information area. The portable storage device comprises a display unit configured to display information relating to the data within the data area or the memory information within the information area, wherein the control unit is further configured to display information on the display unit in response to a memory information inquire signal received when the portable storage device is operatively disconnected from the host.

### BACKGROUND

This description relates to portable storage devices for a computer.

Computers may be configured to connect to peripheral storage devices, such as a CDR/W-ROM, an external hard disk drive (HDD) and a universal serial bus (USB) flash drive, and/or to connect to mass storage media, such as a HDD connected through input/output ports. For example, a USB port is provided as an input/output port for a computer to connect with various peripheral devices through plug-in connections.

The CDR/W-ROM typically requires an additional optical drive. The external HDD conveniently stores large amounts of data, but also is relatively large and therefore not often relied upon as a portable storage device. The USB flash drive is being used more often as it provides portability and increasingly larger storage capacities, e.g., memory capacities of several gigabytes or more. For example, the USB flash drive is often used as a storage medium for a USB host device, such as a digital camera, portable multimedia player (PMP), portable media center (PMC), or personal digital assistant (PDA). In addition, the USB flash drive is used as a peripheral memory device for a personal computer, such as a desktop or notebook computer.

### SUMMARY

In one general aspect, a portable storage device is configured such that a user is able to easily check memory information, such as information on the current status of use of a data storage medium of the portable storage device, regardless of whether the device is connected to or disconnected from a host. For example, the user may be able to monitor memory information relating to a flash memory in a storage drive while in a standalone mode or plug-in mode.

In another general aspect, a portable storage device includes an internal rechargeable battery and memory information within a storage medium is updated when the portable storage device is connected to a host. The portable storage device also includes a display that provides a user with information on the current status of use of data stored within the storage medium when the portable storage device is disconnected from the host.

In another general aspect, a portable storage device includes a housing, a connector extending from the housing and configured for operatively connecting to a host, and a storage medium contained within the housing. The storage medium includes a data area for storing data, and an information area configured to store memory information relating to file resource allocation associated with file data stored within the data area. The portable storage device includes a control unit contained within the housing and configured to store file data transmitted from the host into the data area, to store the memory information in the information area if the portable storage device is operatively connected to the host, and to read the memory information stored in the information area. A display unit is contained within the housing and configured to display information relating to the data within the data area or the memory information within the information area. The control unit is further configured to display information on the display unit in response to a memory information inquire signal received when the portable storage device is operatively disconnected from the host.

Implementations of this aspect may include one or more of the following features. For example, the control unit may be configured to analyze one or more of FAT information and FSINFO information stored in the information area and to output memory information to the display unit in response to the memory information inquire signal. The memory information may include one or more of total storage space, space in use and available space of the storage medium. The control unit may be configured to analyze one or more of FAT, root directory, and entries stored in the information area. The control unit may be configured to output one or more of file directories, file names, and file attributes stored in the data area to the display unit. The control unit may be configured to output one or more of file directories, file names, and file attributes if the memory information inquiry signal is received within a predetermined time relative to displaying memory information. The connector may include a USB plug-in connector configured to connect with a USB port of the host. The control unit may be configured to monitor USB power transmitted from the host to the USB plug-in connector and to detect the connection of the portable storage device with the host based on the USB power transmitted from the host.

The portable storage device may include a battery within the housing, and/or a charge control circuit configured to charge a battery. The battery may be configured to supply an operating voltage to the control unit, the display unit and the storage medium, and the charge control circuit may be configured to charge the battery with USB power transmitted from the host if the plug-in connector is connected with the USB port of the host. The control unit may be configured to detect the connection of the portable storage device with the host. The control unit may be configured to detect a battery voltage level within the portable storage device if the connector is connected with the host. The control unit may be configured activate the charge control circuit if the battery voltage level is lower than a predetermined level. The battery may include a voltage output terminal connected to a switch configured to control the output voltage from the battery to the display unit and the storage medium. The switch may include an analog switch configured to switch to on state and an off state in response to a power control signal output from the control unit.

The portable storage device may include a power path between an output node of the switch and a USB power terminal of the connector, wherein the portable storage device is operated by the USB power supplied from the host through the power path if the plug-in connector is connected with the host. The control unit may be configured to activate or deactivate a voltage path between the battery and the display unit, or between the battery and the storage medium, in response to the detection of a USB voltage. The control unit may be configured activate the voltage path for a predetermined period of time to access the memory information stored in the storage medium and to allow the accessed memory information to be displayed on the display unit. The control unit may be configured to allow the accessed memory information to be displayed on the display unit in response to the memory information inquire signal being received while in a standalone state. The standalone state may be a state where the connector is unplugged from the host, and/or a state where the connector is not powered by the host.

In another general aspect, a method for displaying memory information for a storage medium in a portable storage device includes transmitting file data from the host into the data area, storing file data transmitted from the host into the data area, storing memory information in the information area if the portable storage device is operatively connected to the host, reading the memory information stored in the information area, and displaying display information relating to the data within the data area or the memory information within the information area.

Implementations of this aspect may include one or more of the following features. For example, the memory information inquire signal may be received, and display information may be displayed on the display unit in response to the memory information inquire signal. Memory information about the storage medium may be displayed.

In another general aspect, a method for displaying memory information for a storage medium in a portable storage device includes storing data transmitted from a host into a storage area of the storage medium, updating memory information stored in an information area of the storage medium if the portable storage device is plugged into the host, accessing the memory information stored in the storage medium, and displaying the memory information on a housing of the portable storage device in response to an activation of a memory information button.

Implementations of this aspect may include one or more of the following features. For example, the activation of the memory information button may occur when the portable storage device is disconnected from the host. The activation of the memory information button may occur when the portable storage device is powered from an internal battery within the portable storage device. The memory information may include one or more of storage space in use, available storage space for the storage medium, active file directories, and available file names. The information on the storage space in use and available storage space of the storage medium may be displayed on a display unit of the housing in response to a first memory information inquire signal. The active file directories and file names may be displayed on the display unit in response to a second memory information inquire signal. A voltage level of a battery may be detected, the detected voltage level of the battery may be compared with a predetermined full-charge level, and/or the battery may be charged if the detected voltage level is lower than the full-charge level.

Other features will be apparent from the following description, including the drawings, and the claims.

### BRIEF DESCRIPTION OF THE DRAWINGS

FIG. 1 is a perspective view of a portable storage device.

FIG. 2 is a perspective view of a portable storage device.

FIG. 3 is a block diagram of the portable storage device of FIG. 2.

FIG. 4 is a flowchart of a process for controlling the display of storage information for the portable storage device of FIG. 2.

### DETAILED DESCRIPTION

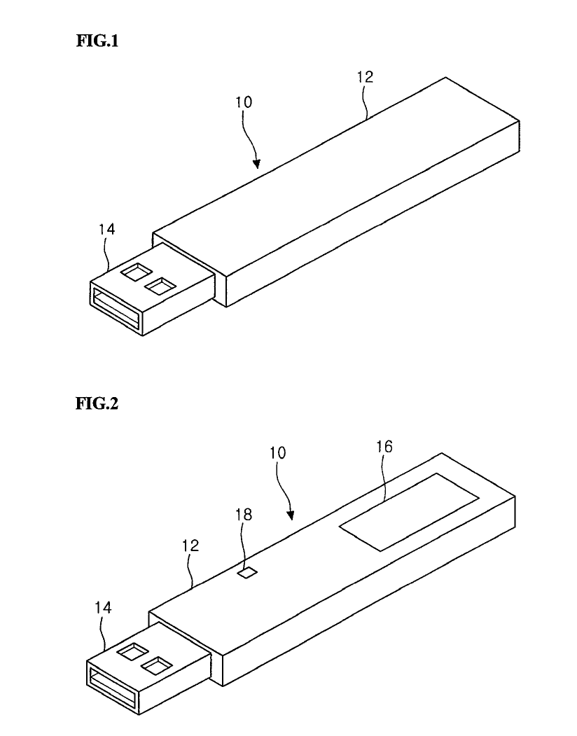

FIG. 1 shows an exemplary USB flash drive 10 which includes a USB plug-in connector 14 protruding outwardly from a housing 12. The housing 12 contains a USB controller and a flash memory. The plug-in connector 14 of the USB flash drive 10 is easily plugged into and out of a USB port of a USB host, such as a notebook computer. If the plug-in connector 14 of the USB flash drive 10 is connected to the USB port, the USB host detects the connection of the USB flash drive 10 to the host through a Hot-Plug/Plug-and-Play (PnP) function.

The USB host exchanges protocol information with the USB controller provided in the USB flash drive 10. The USB host sets up the USB flash drive 10 and obtains access to the flash memory provided therein to access and store data within the USB flash drive 10. The typical USB flash drive 10 merely stores data in the internal flash memory and transmits the stored data to the USB host under the control of the USB host. The USB flash drive 10 is typically connected with a USB host in order to access memory information such as space in use, available space, file directories and file names. In particular, the USB flash drive 10 is connected to the USB host and an application program is operated to access the memory information of the flash memory in the USB flash drive 10. However, the typical USB flash drive does not access flash memory information in a standalone mode, (e.g., when the USB flash drive is not connected to the USB host).

A USB flash drive 10 that includes MPEG audio layer-3 (MP3) functions may be provided with a rechargeable battery and a display panel. The display panel indicates the data exchanged with the USB host and information relating to the MP3 content being 5 accessed through the flash drive 10. However, the information displayed on the display panel includes only the information relating to the recording and playing of the MP3 data.

For example, the information that is displayed typically includes the playing time, lyrics or content of the MP3 data. However, a current status of the flash memory embedded in the USB flash drive 10 is not analyzed and decoded to allow a user to read the data in the USB flash drive 10.

Referring to FIGS. 2-4, a USB flash drive 10 includes features that do not necessarily require a user to connect the USB flash drive 10 with a USB host to operate an application program for retrieving memory information from the USB flash drive 10, including attributes such as total storage space, storage space in use, and available storage space of the flash memory, the file directories, and the file names in the USB flash drive 10. In addition, the USB flash drive 10 permits the user to determine the current status of use of the flash memory embedded in the USB flash drive 10, e.g., in order to determine whether there is available storage capacity for a particular folder or file with a certain size, without connecting the USB flash drive 10 to the USB host.

Referring to FIG. 2, the portable storage device 10 includes a display unit 16 installed on a housing 12, and a plug-in connector 14 protruding outwardly from the housing 12 at one side thereof The display unit 16 allows information output from a circuit mounted on an internal circuit board within the housing 12 to be displayed on the exterior of the housing 12. A memory information button 18 located on the housing 12 provides a memory information inquire signal to a control unit mounted on the circuit board when a user selects and presses the button.

The plug-in connector 14 is plugged into a USB port installed at a USB host (not shown) by a user of the portable storage device 10. The USB host is a digital information processing device formed with a USB port and includes any one or more of a variety of multimedia information processing devices, including, for example, a digital camera, a portable multimedia player (PMP), a portable media center (PMC), a personal digital assistant (PDA), or a personal computer equipped with a USB port. The portable storage device 10 of FIG. 2 is provided with a rechargeable battery for supplying an operating voltage to the circuit mounted on the circuit board and to a storage medium on the internal circuit board, such as a flash memory. If the plug-in connector 14 of the portable storage device 10 is connected to the USB port of the USB host, the portable storage device is automatically recognized by the hot-plug of the USB host and operated as a storage device of the USB host.

If the portable storage device 10 is plugged into the USB port of the USB host, the rechargeable battery contained in the portable storage device 10 is charged with a power supply of 500 mA and 5 V provided through the USB port from the USB host. File data output from the USB host and information on the file system indicating where the relevant file data is stored (e.g. memory information including file allocation table (FAT) and file system information (FSINFO)) are respectively stored under control of the USB host in a data area and an information area of the storage medium.

The FAT and FSINFO are a general-purpose file allocation table method used in a personal computer and are generally used to represent a variety of file systems used in personal computers. For example, the file management system may include DOS and Virtual FAT (VFAT) for use in Windows 95/98, FAT32 for use in Windows 98/ME/2000, and NT File System (NTFS) for use in Windows NT or Windows 2000.

The FSINFO, which is an information area for storing information including the last sector number of a stored file, is updated whenever a file is written into or deleted from the data area in order to easily calculate any empty space (available space) of the data area.

If the portable storage device 10 is unplugged from the USB port of the USB host, the internal circuit of the portable storage device 10 operates in a standalone state and is powered by the internal battery. The initial operation of the device 10 while in a standalone state is supported by a standby voltage provided only to the control unit mounted on the circuit board in the housing 12. Accordingly, the portable storage device 10 does not necessarily have to be connected to and/or powered by a USB host to be operated while in the standby state.

If a user presses the memory information button 18 installed on the housing 12 while the portable storage device 10 is in a standby state, the control unit of the portable storage unit 10 selectively reads out information on FSINFO, FAT, root directory and entries stored in the information area of the storage medium. The control unit then outputs information relating to the storage medium space in use and available storage medium space, and/or attributes, such as file directories and file names to the display unit 16 for observation by a user.

If the user presses the memory information button 18 installed on the housing 12 in a standalone mode, the user can easily confirm the information about the storage medium, including, for example the space in use, the available space, the file directories and the file names, through the display unit 16. Therefore, the portable storage device 10 can be more conveniently employed.

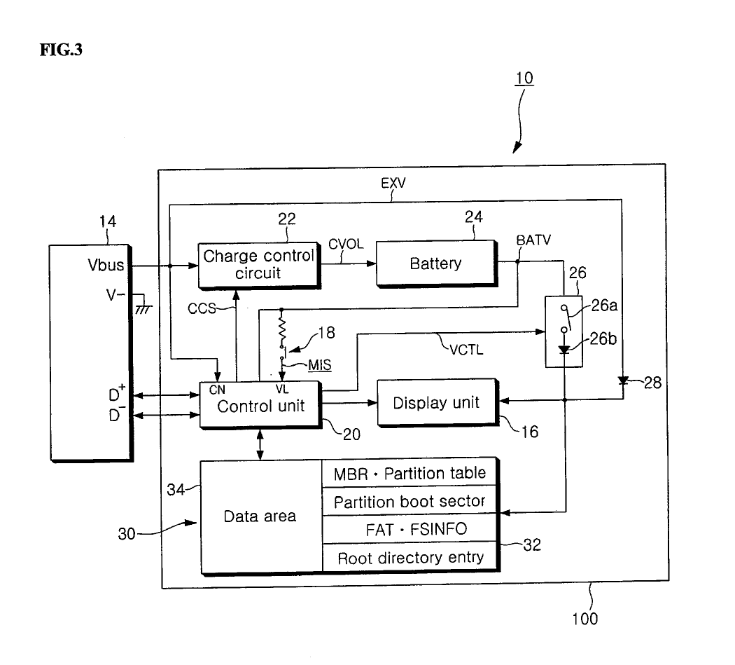

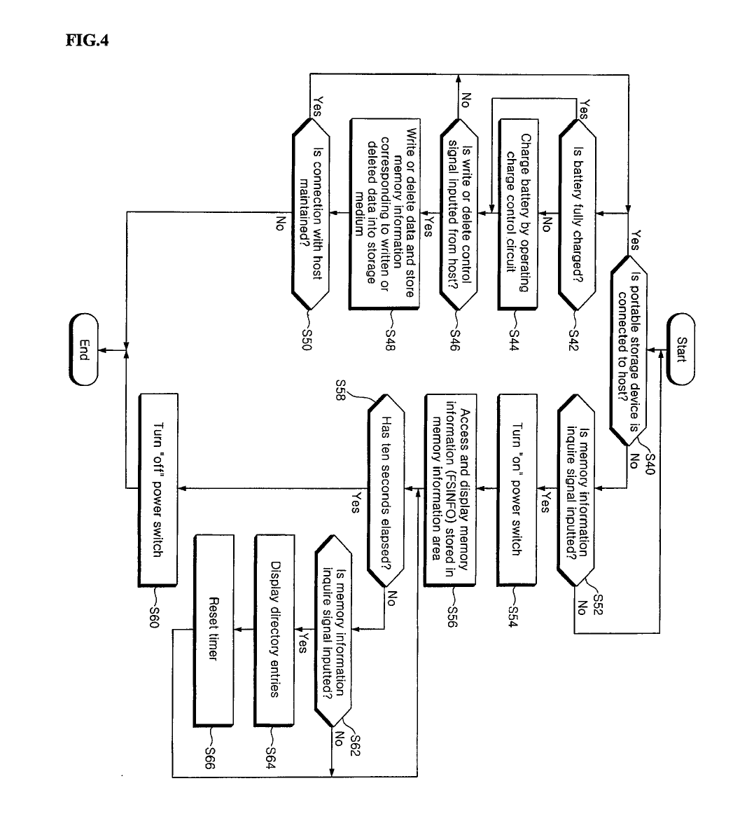

Referring to FIG. 3, the plug-in connector 14 is provided with two voltage terminals (Vbus and V−) and two data terminals (D+ and D−). The plug-in connector 14 protrudes outwardly from the housing 12 of the portable storage device 10 as shown in FIG. 2. The voltage terminals and the data terminals of the plug-in connector 14 are connected to the circuit board 100 installed within the housing 12 of the portable storage device 10. The circuit board 100 is electrically connected to a display unit 16, a memory information button 18, a control unit 20, a charge control circuit 22, a battery 24, a switch 26, a storage medium 30, and a diode 28. The switch 26 includes a switching terminal 26a in series with a diode 26b. The diodes 26b and 28 are installed to prevent a reverse voltage across the battery 24.

The storage medium 30 is, for example, a flash memory storage device. If the flash memory device is initially formatted, the storage medium 30 is divided into an information area 32 including, for example, a master boot record (MBR), a partition table, a partition boot sector, a file allocation table (FAT), file system information (FSINFO), and a root directory, and a data area 34 for storing file data. A variety of information in the information area 32 is either referred to when data is written in or read out from the data area 34 or is updated to record the status of the flash memory when the data area of the flash memory is increased or decreased by recording or deleting data. When a data file is stored in the data area, the information on the relevant file, such as a directory, file name, and/or file attributes, is recorded in the FAT among the data stored in the information area 32. The FSINFO stores information, including the information on the last section number of the recorded file, to allow the stored information to be conveniently used for calculating storage medium space in use and available storage medium space.

Standby Mode of Portable Storage Device 10

Referring to FIG. 4, an exemplary process for displaying and operating the portable storage device includes a plug-in state and a standalone state. When the portable storage device 10 is unplugged from the USB port of a USB host, the control unit 20 of the portable storage device 10 of FIG. 3 operates in the standalone state, which includes a standby mode and a memory information confirmation mode, and is supplied with power through the battery voltage BATV output from the battery 24. In contrast, the portable storage device operates in the plug-in mode if the plug-in connector 14 of the portable storage device 10 is plugged into the USB port of the USB host, and is supplied with power from the USB port.

The control unit 20 detects the presence of a voltage at the voltage terminal Vbus of the plug-in connector 14 to determine whether the portable storage device is connected to the host (step S40 of FIG. 4) when operating in the standby mode. In the standby mode, the switch (see FIG. 3) is “turned off” to cut off the battery voltage BATV provided for the display unit 16 and the storage medium 30 from the battery 24 and to thereby conserve the power of the battery 24. The portable storage device operates in the memory information confirmation mode if a user selects and presses the memory information button 18 installed on the housing 12 in a state where the connector is unplugged from the USB port of the USB host.

Operation of Portable Storage Device 10 Plugged in USB Host

If the plug-in connector 14 of the portable storage device 10 is plugged into the USB port of the USB host, a power supply of 500 mA, 5 V is output from the voltage terminal Vbus of the plug-in connector 14 through the USB port of the USB host. The voltage of 5 V output from the voltage terminal Vbus of the plug-in connector 14 is provided as an operation voltage capable of operating the charge control circuit 22, the display unit 16, and the storage medium 30.

The control unit 20 detects the connection of the portable storage device to the host by the presence of the voltage of 5 V output from the voltage terminal Vbus of the plug-in connector 14 (step S40 of FIG. 4). In step S40, the control unit 20 determines if the portable storage device is connected to the host. In step S42, the control unit 20 determines whether the battery 24 has been fully charged by comparing a voltage level of the output voltage BATV of the battery 24 input to an input port VL with a predetermined full-charge level.

If the control unit determines that the voltage BATV level of the battery 24 is lower than the predetermined full-charge level, the control unit 20 recognizes that the battery 24 has not yet been fully charged. The control unit then provides a charging control signal (CCS) to the charge control circuit 22 during step S44. The charge control circuit 22 charges the battery 24 with the voltage of 5 V output from the voltage terminal Vbus of the plug-in connector 14 in response to the charging control signal (CCS) output from the control unit 20.

In step S46, the control unit determines if a write or delete control signal has been input from the host. If no signal has been input, the process returns to step S42. If a control signal has been input by the host, the appropriate data is written to or deleted from the portable storage device in step S48. The control unit 20 reads the output of the data terminals D+ and D− of the plug-in connector 14 and determines whether a write or delete control signal is input from the host (step S46). If it is determined that the write or delete control signal is transmitted from the host, the control unit 20 stores or deletes a data file into or from the data area 34 of the storage medium 30 and then updates the information on FAT, FSINFO, root directory, and entry stored in the information area 32 (step S48).

For example, if a file data write control signal is input from the host, the control unit 20 writes the file data transmitted from the host into the data area 34, writes the information on the sector allocated for the stored file data into the FAT, and then writes the information on the recently stored sector into the FSINFO. In addition, the control unit 20 writes all the information, such as a relevant allocated directory, file name, attribute, file size, start cluster number, writing date, writing time, and/or creator, into the root directory and entry area.

In contrast, if a file data delete control signal is input from the host, the control unit 20 deletes a file stored in the data area 34 and also deletes the information on the directory allocated to the file data from the FAT. The control unit 20 then writes the information on the sector corresponding to the file deleted from the data area 34 into the FSINFO and deletes all the information on the relevant directory from the root directory and entry area to thereby update the memory information. The last sector number of file data stored in the data area 34 and the number of deleted sectors are stored in the FSINFO as described above. However, if the file data is also stored on the storage device 10, the sectors do not have to be read from the first to the last, and the additional file data is directly stored in the storage device. For example, the FSINFO is used as information for maintaining and tracking an available space (empty space) of the storage medium 30.

If the operations shown in step S48 are performed, the file allocation table (FAT) information of the file data stored in the data area 34, the information on the sector (FSINFO) where the file data are most recently stored, the directory of the stored file and the attributes (creator, file size, file name, file type, update date, access date) of the stored file are all stored in the information area 32 of the storage medium 30.

In step S50, the control unit 20 that has performed the operations in step S48 determines whether the portable storage unit is still connected to the host by detecting the output of the voltage terminal Vbus of the plug-in connector 14. If the control unit determines that a voltage is output from the voltage terminal Vbus of the plug-in connector 14, the portable storage unit is recognized as still being connected to the host. The process then goes to step S42 to repeated performance of the aforementioned series of process steps, e.g., S42-S48.

Thus, in the plug-in mode, the portable storage device 10 writes or deletes the file data into or from the data area 34 of the internal storage medium 30 according to the data write or delete control input by the host, and then updates the memory information, such as the FAT, FSINFO, root directory, and entry.

If a voltage is not output from the voltage terminal Vbus of the plug-in connector 14, the control unit 20 recognizes that the portable storage device is not connected to the host and then terminates the plug-in mode of the portable storage device.

Memory Information Confirmation Mode of Portable Storage Device 10

If the user presses the memory information button 18 provided on the housing 12 while the device is in the standby mode, i.e. a standalone state where the portable storage device 10 is unplugged from the host or the host is not providing power to the portable storage device 10, a memory information inquire signal (MIS) at a logical state of “high” is provided to the control unit 20.

In step S52, the control unit 20 determines if the memory information inquire signal (MIS) is activated, and turns on the switch 26 by activating a power control signal VCTL in step S54 if a memory information inquire signal has been initiated by the user. If the switch 26 is “turned on,” the voltage BATV of the battery 24 is provided as a driving voltage for operating the display unit 16 and the storage medium 30.

After performing the process of step S54, the control unit 20 reads information on the FSINFO stored in the information area 32 of the storage medium 30, calculates the memory information such as total storage space, storage space in use and available storage space, and transmits the calculated memory information to the display unit 16.

Since the last sector number of the file data most recently stored in the data area 34 and the sector number of the deleted file data are stored in the FSINFO as described above, the information on the space in use and the available space can be obtained by calculating the number of sectors where the file data are most recently stored and the number of deleted sectors on the basis ofthe total sector number ofthe data area 34. Specifically, in step S56, the information on the total storage capacity, the storage capacity in use, and the available storage capacity of the data area 34 are accessed and displayed.

In step S58, the control unit 20 that has displayed the information on the total storage capacity, space in use and available space of the data area 34 of the storage medium 30 to the outside through the display unit 16 determines whether a predetermined period of time, i.e. ten seconds, has elapsed. However, although the predetermined period of time may be set to ten seconds, the elapsed time period can be modified to any number of shorter or longer predetermined periods, e.g., 5 seconds, 15 seconds, 25 seconds or any other interval after the button 18 has been depressed or the data displayed.

If it is determined in step S58 that ten seconds have elapsed, the control unit 20 “turns off” the switch 26 by deactivating the power control signal VCTL in step S60. Since the path of the voltage provided to the display unit 16 and the storage medium 30 is cut off if the switch 26 is turned off, the power from the battery 24 can be preserved in a standalone state.

If the predetermined time period has not yet elapsed, the control unit determines in step S62 if the user has selected and pressed the memory information button 18 in a state where the memory information of the storage medium 30 is displayed on the display unit 16. If a memory information inquire signal has been initiated, the control unit 20 reads the information on the FAT, root directory and entries stored in the information area 32 and outputs the file directories stored in the data area 34 onto the display unit 16 (step S64) and then resets a timer (step S66). The user is conveniently provided with useful information about the portable storage device 10, such as information relating to the detailed directories of the storage medium 30.

When the display size is not sufficient to display all of the information, the information on the storage space in use and available storage space of the storage medium can be displayed in response to the input of a first memory information inquire signal, and the file attributes, such as file directories and file names, can be displayed in response to the input of a second memory information inquire signal. More generally, the information on the storage space in use and available storage space can be displayed in response to the input of an odd-numbered memory information inquire signal, and the information on the file directories, file names, extension names and creators can be displayed in response to the input of an even-numbered memory information inquire signal.

Although the information on the total storage space, storage space in use and available storage space of the data area 34 is calculated using the FSINFO information stored in the information area of the storage medium 30, and the calculated information is then displayed on the display unit 16, it should be noted that the FAT information can also be used in addition to, or as an alternative to, the FSINFO information. For example, a process of obtaining the information on the available space of the data area 34 by reading all the FAT information in the information area 32 and then calculating the FAT information in which file data are not allocated may be alternatively employed.

As described above, the current status of data, e.g., memory information, stored in the storage medium can be confirmed even when the portable storage device is in a standalone mode, e.g., where the portable storage device is not connected with the host or is not being powered by the host.

Other features will be apparent from the following description, including the drawings, and the claims. For example, although a flash memory has been described as an example of a storage medium, a hard disk or other memory device can be used as the storage medium of the above-described portable storage device.

What is claimed is:

1. A portable storage device, comprising:
a housing;
a connector extending from the housing and configured for operatively connecting to a host;
a storage medium contained within the housing and including
a data area for storing data, and
an information area configured to store memory information relating to file
resource allocation associated with file data stored within the data area;
a control unit contained within the housing and configured to store file data transmitted from the host into the data area, to store the memory information in the information area if the portable storage device is operatively connected to the host, and to read the memory information stored in the information area; and
a display unit contained within the housing and configured to display information relating to the data within the data area or the memory information within the information area, wherein the control unit is further configured to display information on the display unit in response to a memory information inquire signal received when the portable storage device is operatively disconnected from the host.

2. The device as claimed in claim 1, wherein the control unit is configured to analyze one or more of FAT information and FSINFO information stored in the information area and to output memory information to the display unit in response to the memory information inquire signal.

3. The device as claimed in claim 2, wherein the memory information includes one or more of total storage space, space in use and available space of the storage medium.

4. The device as claimed in claim 2, wherein the control unit is configured to analyze one or more of FAT, root directory, and entries stored in the information area.

5. The device as claimed in claim 4, wherein the control unit is configured to output one or more of file directories, file names, and file attributes stored in the data area to the display unit.

6. The device as claimed in claim 5, wherein the control unit is configured to output one or more of file directories, file names, and file attributes if the memory information inquiry signal is received within a predetermined time relative to displaying memory information.

7. The device as claimed in claim 6, wherein the connector comprises a USB plug-in connector configured to connect with a USB port of the host.

8. The device as claimed in claim 6, wherein the control unit is configured to monitor USB power transmitted from the host to the USB plug-in connector and to detect the connection of the portable storage device with the host based on the USB power transmitted from the host.

9. The device as claimed in claim 6, further comprising:
a battery within the housing; and
a charge control circuit configured to charge the battery.

10. The device as claimed in claim 9, wherein the battery is configured to supply an operating voltage to the control unit, the display unit and the storage medium, and the charge control circuit is configured to charge the battery with USB power transmitted from the host if the plug-in connector is connected with the USB port of the host.

11. The device as claimed in claim 1, wherein the control unit is configured to detect the connection of the portable storage device with the host.

12. The device as claimed in claim 11, further comprising:
a battery within the housing; and
a charge control circuit configured to charge the battery.

13. The device as claimed in claim 12, wherein the control unit is configured to detect a battery voltage level within the portable storage device if the connector is connected with the host.

14. The device as claimed in claim 13, wherein the control unit is configured activate the charge control circuit if the battery voltage level is lower than a predetermined level.

15. The device as claimed in claim 14, wherein the battery comprises a voltage output terminal connected to a switch configured to control the output voltage from the battery to the display unit and the storage medium.

16. The device as claimed in claim 15, wherein the switch comprises an analog switch configured to switch to on state and an off state in response to a power control signal output from the control unit.

17. The device as claimed in claim 16, further comprising a power path between an output node of the switch and a USB power terminal of the connector, wherein the portable storage device is operated by the USB power supplied from the host through the power path if the plug-in connector is connected with the host.

18. The device as claimed in claim 17, wherein the control unit is configured to activate or deactivate a voltage path between the battery and the display unit, or between the battery and the storage medium, in response to the detection of a USB voltage.

19. The device as claimed in claim 18, wherein the control unit is configured activate the voltage path for a predetermined period of time to access the memory information stored in the storage medium and to allow the accessed memory information to be displayed on the display unit.

20. The device as claimed in claim 19, wherein the control unit is configured to allow the accessed memory information to be displayed on the display unit in response to the memory information inquire signal being received while in a standalone state.

21. The device as claimed in claim 20, wherein standalone state is a state where the connector is unplugged from the host.

22. The device as claimed in claim 20, wherein the standalone state is a state where the connector is not powered by the host.

23. A method for displaying memory information for a storage medium in a portable storage device as recited in claim 1, the method comprising:
transmitting file data from the host into the data area;
storing file data transmitted from the host into the data area;
storing memory information in the information area if the portable storage device is operatively connected to the host;
reading the memory information stored in the information area; and
displaying display information relating to the data within the data area or the memory information within the information area.

24. The method as claimed in claim 23, further comprising:
receiving the memory information inquire signal; and
displaying display information on the display unit in response to the memory information inquire signal.

25. The method as claimed in claim 24, further comprising displaying memory information about the storage medium.

26. A method for displaying memory information for a storage medium in a portable storage device, the method comprising:
storing data transmitted from a host into a storage area of the storage medium;
updating memory information stored in an information area of the storage medium if the portable storage device is plugged into the host;
accessing the memory information stored in the storage medium; and
displaying the memory information on a housing of the portable storage device in response to an activation of a memory information button.

27. The method as claimed in claim 26, wherein the activation of the memory information button occurs when the portable storage device is disconnected from the host.

28. The method as claimed in claim 26, wherein the activation of the memory information button occurs when the portable storage device is powered from an internal battery within the portable storage device.

29. The method as claimed in claim 26, wherein the memory information comprises one or more of storage space in use, available storage space for the storage medium, active file directories, and available file names.

30. The method as claimed in claim 29, wherein the information on the storage space in use and available storage space of the storage medium is displayed on a display unit of the housing in response to a first memory information inquire signal.

31. The method as claimed in claim 30, wherein the active file directories and file names are displayed on the display unit in response to a second memory information inquire signal.

32. The method as claimed in claim 27, further comprising:
detecting a voltage level of a battery;
comparing the detected voltage level of the battery with a predetermined full-charge level; and
charging the battery if the detected voltage level is lower than the full-charge level.
